(19) United States
(12) Patent Application Publication
(10) Pub. No.: US 2002/0049606 A1
(43) Pub. Date: Apr. 25, 2002

(54) Interactive learning device using web-based system and method therefor

(75) Inventors: Byung Ju Dan, Kyungki-Do (KR); Jong Rak Lim, Kyungki-Do (KR); Jae Ho Na, Kyungki Do (KR); Jang Won Boo, Seoul (KR); Hee Il Wang, Seoul (KR); Nam Woong Kim, Seoul (KR); Wae Yeul Kim, Kyungki-Do (KR); Mun Chae Joung, Seoul (KR); In Sang Song, Kyungki-Do (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 09/855,936

(22) Filed: May 15, 2001

(30) Foreign Application Priority Data
May 16, 2000 (KR) 26033/2000
Aug. 17, 2000 (KR) 47552/2000

(51) Int. Cl. G06F 17/60

(52) U.S. Cl. 705/1; 709/201

(57) ABSTRACT

A system for programming an interactive learning device, such as electronic toy, using a web server includes a first processing unit having a web server for providing a control module used for remote processing, a second processing unit linked to the first processor through the communication medium to exchange data with the first processor, an interactive device, such as a robot toy pet, having at least a processor and a memory and adapted to communicate with the first processing unit. The interactive device includes a sensor for collecting data and formulating a learned module. The interactive device receives the control module from the first processing unit and sends the learned module. The control module is updated with more advanced function to be performed by the interactive toy in response to the content of the learned module.

### BACKGROUND OF THE INVENTION

1. Field of the Invention

The present invention relates to an interactive system, and more particularly, to an interactive processing device, such as electronic toys, adapted to be managed, upgraded and modified by using communication networks, such as the Internet.

2. Description of the Related Art

Recently, toys having a learning/growing function have been introduced into the marketplace and are gaining popularity. One type of a learning/growing toy is the virtual animal or virtual plant, which can be “raised” or “grown” on-line through the Internet. Users can customize how their virtual animal or plant looks, acts, and/or changes with time, and by selecting certain features of the virtual animal or plant, the virtual toy becomes customized (i.e. “grow”) to the user's preferences. More recently, physical toys in the shape of dogs, cats, birds, fish, etc. have been released that learn or grow with the user (or purchaser). Marketed under such names as Poo-chis, Robo-toys, or Robo-pets, these interactive toys can learn and grow by adjusting a key of a remote controller by a user or by using voice recognition technology. For example, a robo-dog can be programmed to respond to voice commands, sing songs, and do tricks based on training from the user. Moreover, the amount of interaction by the user directly affects the customization of the robo-pet to the user. Thus, as a toy “learns” or “grows” for a predetermined time, it matures into a more “intelligent” or functionally sophisticated toy.

Although existing interactive toys are popular with users for the short term, users often lose interest in the toys after a short time. Initial instructions accompanying the toy give limited guidance to the user and without a means of comparison with different toys of other users, the growth of the toys can become monotonous. By failing to stimulate the continuous interest of the user, the full capabilities of the interactive toys are often left untapped. Moreover, because the interactive toys are sold generically, the particular interactive toy cannot reflect the tastes or preferences of a particular user. The lack of initial customization often leads to a quicker loss of interest.

### SUMMARY OF THE INVENTION

Therefore, an object of the present invention is to provide a method for purchasing and managing a learning/growing type of device using a web server, for which various types of character patterns of devices are provided in a web server and the psychology and taste of a purchaser are analyzed to give a device a character pattern according to the purchaser's taste, and along with its corresponding system.

Another object of the present invention is to provide a method for purchasing and managing an interactive learning/growing type device using a web server that is capable of stimulating a user's continuous interest to a device by means of an improved learning/growing process, providing a user comparison table which allows different users to compare the growth state of their own devices, and allowing users to objectively compare a degree of maturity of a device through various contests in a cyber space through the web server.

In the present invention, since a device can be directly connected to the Internet through a communication port, a device user can input a learned content of a device and the fully grown model at its step to the web server without passing through a personal computer, so that the user can download an improved control software.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve at least the above objects in whole or in parts, there is provided a system for purchasing and managing of an interactive learning/growing type device using a web server including: a web server for providing a profile data having information for surveying and analyzing preferences of a purchaser, generating data for fabricating a device suiting a purchaser tastes according to the information described in the profile data, processing an order content of the purchaser in case the purchaser desires to purchase the device directly without utilizing the psychology and taste analysis, determining a degree of maturity of the device according to the learned content and the fully grown model of the device at a certain step of development as inputted by the purchaser, and providing an upgraded control software and/or hardware for the device; a personal computer for downloading a profile form through the Internet, providing the profile form to the purchaser, inputting a response of the purchaser to the profile form, downloading the learned content from the device through a communication unit after a predetermined learning period elapses and inputting the learned content to the web server; and a device for receiving fabrication data generated in the web server and the upgraded control software and/or hardware through the personal computer or directly through the wireless Internet.

To achieve at least these advantages in whole or in parts, there is further provided a method for purchasing and managing a learning/growing type device using a web server including: a step in which a web server inquires a purchaser whether he or she wants a profile for analyzing his or her psychology and taste; a step in which the purchaser inputs his or her psychology and taste according to a certain profile provided by the web server to determine a character pattern of a device according to the inputted response result of the purchaser, that is, according to the psychology and taste of the purchaser; a step in which the web server provides a control software and/or hardware corresponding to the determined character pattern of a device to the device and a company sells the device to the purchaser; a step in which the purchaser receives he device selected by the web server and learns and grows the device; a step in which the learned/grown content is provided to the web server if the user wants upgrading of the device according to the learned/grown content; and a step in which the web server receives the learned content of the device and the finally grown model at its step selected by the purchaser, determines a degree of maturity of the device and a device company sells the upgraded control software and/or hardware of the device to users according to the degree of maturity.

To achieve at least these advantages in whole or in parts, there is further provided a method for purchasing of a learning/growing type device using a web server including: a step in which a purchaser inputs his or her own psychology and taste according to a certain profile provided from the web server and the web server determines a character pattern of a device according to the inputted response result of the purchaser, that is, according to the purchaser's psychology and taste; and a step in which the device company provides a control software and/or hardware corresponding to the determined character pattern of the device to the device and sells it to users.

To achieve at least these advantages in whole or in parts, there is further provided a method for managing of a learning/growing type device using a web server including: a step in which a device purchaser purchases a learning/growing type device in an online or in an offline; a step in which the user (the device purchaser) makes the device to learn and grow; a step in which the learned/grown content is provided to the web server if the user wants upgrading the device according to the learned/grown content; and a step in which the web server receives the learned content of the device and the finally grown model at its step selected by the purchaser, determines the degree of maturity of the device, and provides a user comparison table for a degree of maturity and a maturity level table by grow types to the purchaser, and a device company sells an upgraded control software and/or hardware for the device to a user.

According to one embodiment of the present invention, a system for exchanging information over a communication medium comprises a first processor having a server for providing a control module used for remote processing, wherein the control module is selectively chosen; a second processor linked to the first processor through the communication medium to exchange data with the first processor; an interactive device having at least a processor and a memory and adapted to communicate with the first processor, wherein the interactive device includes a sensor for collecting data and formulating a learned module, the interactive device receiving the control module from the first processor and sending the learned module to the first processor, and wherein the control module from the first processor is selectively chosen in response to the learned module; and a communication link for linking the interactive device to the second processor, wherein the control module includes an executable program for sensory functions to be performed by the interactive device.

According to one aspect of the present invention, the interactive device performs physical motor functions in response to the control module received from the first processor. Preferably, the learned module is responsive to an operation duration of the interactive device.

According to another aspect of the present invention, an updated control module is selected in the first processor in response to the learned module to allow the interactive device to perform more advanced functions.

According to another embodiment of the present invention, an interactive device for use with a remote processing device having a server for providing a control module used for remote processing comprises an internal processor for receiving and executing the control module; a memory for storing data; a communication port adapted to communicate with the remote processing device; a sensor for collecting data and outputting to the processor, wherein the processor compiles a learned module based on sensory data and communicates to the first processor to receive an updated control module in response to the learned module.

According to one aspect of the present invention, the interactive device further comprises a motor controller for controlling movement of the interactive device in response to the control module received from the first processor.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

FIG. 1 is a schematic overview diagram of the network computing environment in which the preferred embodiments are implemented;

FIG. 2 illustrates software components in the web server in accordance with the preferred embodiments of the present invention;

FIG. 3 is a block diagram illustrating an overview construction of the system for purchasing and/or managing an interactive toy over the Internet in accordance with a preferred embodiments of the present invention;

FIG. 4 is a detailed view of a toy of FIG. 3 in accordance with the preferred embodiments of the present invention;

FIG. 5 illustrates a purchase system of an interactive learning/growing type toy using a web server in accordance with the preferred embodiments of the present invention;

FIG. 6 is a flow chart of a method for purchasing a learning/growing type toy using a web server in accordance with the preferred embodiments of the present invention;

FIG. 7 illustrates a managing system for a learning/growing type toy using a web server in accordance with the preferred embodiments of the present invention;

FIG. 8 is a flow chart of a method for managing a learning/growing type toy using a web server in accordance with the preferred embodiments of the present invention;

FIG. 9 is a diagram showing profile items of a toy purchaser to be provided to the web server in accordance with the preferred embodiments of the present invention;

FIG. 10 is an exemplary illustration of questions for checking psychology of the profile of FIG. 9 in accordance with the preferred embodiments of the present invention;

FIG. 11 is an exemplary illustration of control software corresponding to each character pattern of toys in accordance with the preferred embodiments of the present invention;

FIG. 12 is a diagram showing a method for determining a degree of maturity of a toy in accordance with the preferred embodiments of the present invention;

FIG. 13 is an exemplary illustration of types of finally grown model of learned/grown toys and pertinent development steps in accordance with the preferred embodiments of the present invention;

FIG. 14 is a graph showing comparison of the number of users of toys for a development by steps of toys in accordance with the preferred embodiments of the present invention; and

FIG. 15 is database included in the web server in accordance with the preferred embodiments of the present invention.

### DETAILED DESCRIPTION OF THE PREFERRED EMBODIMENTS

The preferred embodiments are directed to a method, system and program for consumers to purchase customized interactive learning devices, such as toys, and provide greater interactivity for the toys over any communication network, such as the Internet. In the following description, reference is made to the accompanying drawings which form a part hereof and which illustrate the preferred embodiment of the present invention. It is understood that other embodiments may be utilized and structural and operational changes may be made without departing from the scope of the present invention. For example, although the preferred embodiments are described in the context of an interactive toy, the present application can apply to any device that is customized to a user's preferences and tastes before delivery, and the “development” of the device is compared after further customization by the user.

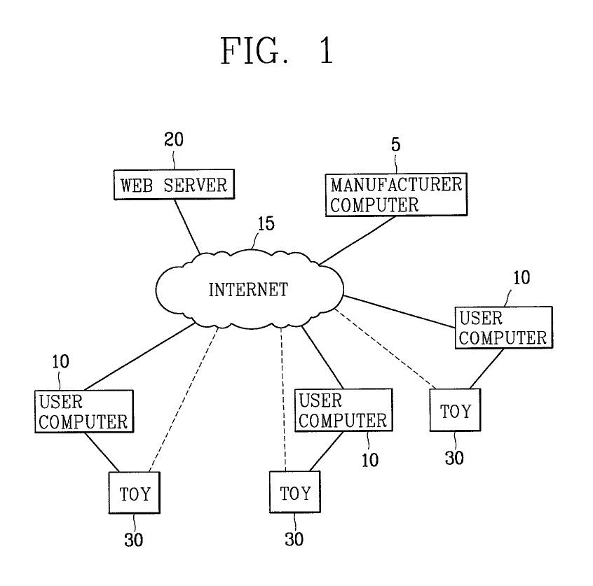

FIG. 1 is a schematic overview diagram of the network computing environment in which the preferred embodiments are implemented. In preferred embodiments, user computers 10 can access a web server 20 using a network 15, such as the Internet. The network 15 may be comprised of any network system known in the art including TCP/IP based networks (e.g., an Intranet, the Internet), LAN, Ethernet, WAN, Token Ring, etc. Alternatively, there may be separate and different networks between the components. Further, because the preferred embodiment of the network 15 is the Internet, there can be numerous users using the network 15 simultaneously, however only three user computers 10 are shown for illustration purposes. Interactive toys 30 can be directly connected to the user computers 10 by means of a communication port, such as a serial port, parallel port or USB connection or other suitable ports known to one of ordinary skill in the art. However, in alternative embodiments, interactive toys 30 may connect to network 15 by means of a wireless Internet connection avoiding the use of the user computers 10. In addition, the network 15 also connects the web server 20 to a manufacturer computer 5 where the web server 20 can deliver customized orders for the toys 30.

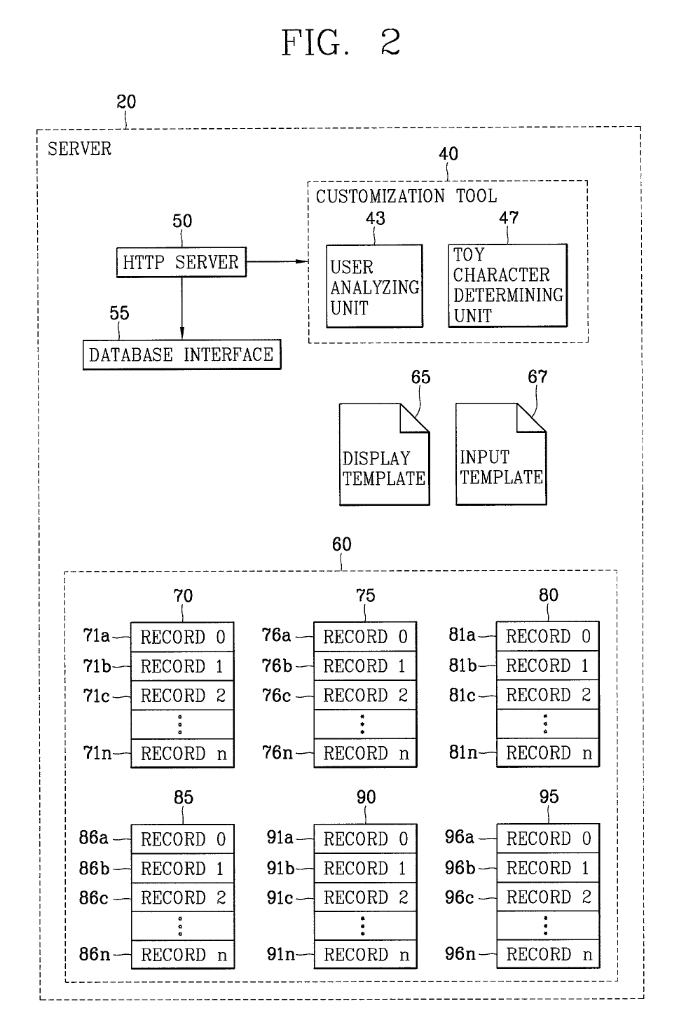

FIG. 2 illustrates software components in the preferred embodiment of the web server 20, including a Hypertext Transfer Protocol (HTTP) server 50, database 60, database interface 55, customization tool 40, and templates 65 and 67. The HTTP server 50 responds to requests from the user computers 10 using HTTP client programs, such as1 web browser programs known in the art. Upon accessing the HTTP server 50 through the network 15 using a unique network address (i.e. an IP address), the database interface 55 will give specific access to certain parts of database 60 depending on the secured identification provided by the user computer 10 (e.g. unique username, unique toy name, identification number, password, etc.).

The database 60 keeps current information about the users (or purchasers) of the interactive toy, the interactive toys themselves, and variety of other information needed to provide information throughout the website. The database 60 comprises a database program known in the art, such as a relational database program. In the preferred embodiment, the database 60 includes six database tables 70, 75, 80, 85, 90, and 95. A user database table 70, which includes user records 71a, b, . . . n, is used in the preferred embodiment to track user information. Each record 71a, b, . . . , n belongs to a unique user keeping track of a purchaser information gathered from the user. Fields within a record 71a, b, . . . or n keeps information such as user name, password, credit card information, address, user's tastes and preferences, purchase record, etc. In addition, a manual database table 75 includes records 76a, b, . . . n which is used in the preferred embodiment to keep generic information about the website, instructions to the web server 20, and introductory information about the interactive toys. Moreover, database tables 80, 85, 90, 95, each with records 81a, b, . . . n, 86a, b, . . . n, 91a, b, . . . n, and 96a, b, . . . n, keep track of a variety of other information about the interactive toys themselves, the interaction of the toys and users within the website, and information about upgrades to both software and hardware of the interactive toys. Additional detail of the database tables 75, 80, 85, 90, and 95 will be discussed with respect to FIG. 15.

The database interface 55 may comprise a Common Gateway Interface (CGI) program, a Java servlet, or other web page implementation known in the art to present the information in database 60 in a presentable format (e.g. HTML page, etc.). In preferred embodiments, the database interface 55 uses a secured login/password verification for identifying the individual user contacting the HTTP server 50. The assigning of a secured login/password can occur when the user purchases an interactive toy, visits the website, or other means known in the art. The unique identification will allow the database interface 55 to identify which user record 71a, b, . . . n belong to the requesting party and will appropriately give read/write capabilities to the user record 71a, b, . . . n.

The server 20 further stores a display template 65 and an input template 67, which are preferably implemented in a document in which dynamic content may be generated (i.e. HTML, Extended Markup Language (XML) Document, etc.). Differing variations of the display template 65 and input template 67 exists for both user information and the interactive toys, depending on the information to be displayed or inputted, but a single display template 65 and a single input template 67 are used for illustration purposes in FIG. 2. The display template 65 is used to provide the user computers 10 with specific user and toy information from the database tables 70, 75, 80, 85, 90, and 95. The database interface 70 generates data into the display template 65 from one or more of the records 71a, b, . . . n, 76a, b, . . . n, 81a, b, . . . n, 86a, b, . . . n, 91a, b, . . . n, and/or 96a, b, . . . n in the database 60. The input template 67 is used by the web server 20 to collect data from the users or toys and stores the collected information in one or more records 71a, b, . . . n, 76a, b, . . . n, 81a, b, . . . n, 86a, b, . . . n, 91a, b, . . . n, and/or 96a, b, . . . n in the database 60.

The database 60, display template 65, and input template 67 are preferably stored in a non-volatile storage system, such as one or more hard disk drives, used by the server 10 for storage. The server 20 may load data from the storage system into volatile memory (not shown) when processing.

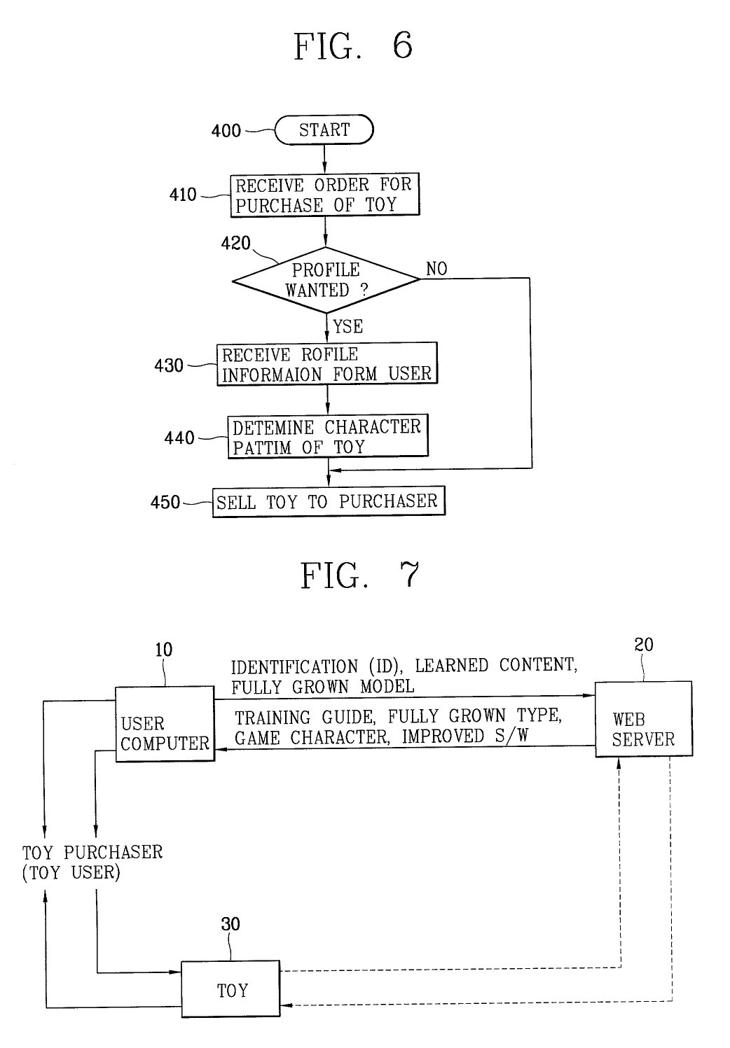

As shown in FIG. 2, the web server 20 also includes a customization tool 40. The HTTP server 50 will access the customization tool 40 when a purchaser desires to pre-customize the toy 30 before purchase. The HTTP server 50 can provide a profile form to the purchaser based on the input template 67 and receive the corresponding answers inputted by the purchaser. The responses are sent to a user analyzing unit 43 of the customization tool 40, which gives values to the responses and analyzes the response values to determine the purchaser's preferences and tastes based on a predetermined valuation formula. The analysis results are passed to toy character determining unit 47, which selects a character for the toy 30 from a group of predefined toy character patterns that best match the purchaser's tastes and preferences. Additional details on the workings of the customization tool 40 will be given with regards to FIG. 6.

The server 20, manufacturer computer 5 and user computers 30 may comprise any type of computer device known in the art, including server, personal computer, mainframe, workstation, hand held device, etc. Moreover, the server 20 may comprise one or more separate computer systems to run the different program components 40, 50, 55, and 60.

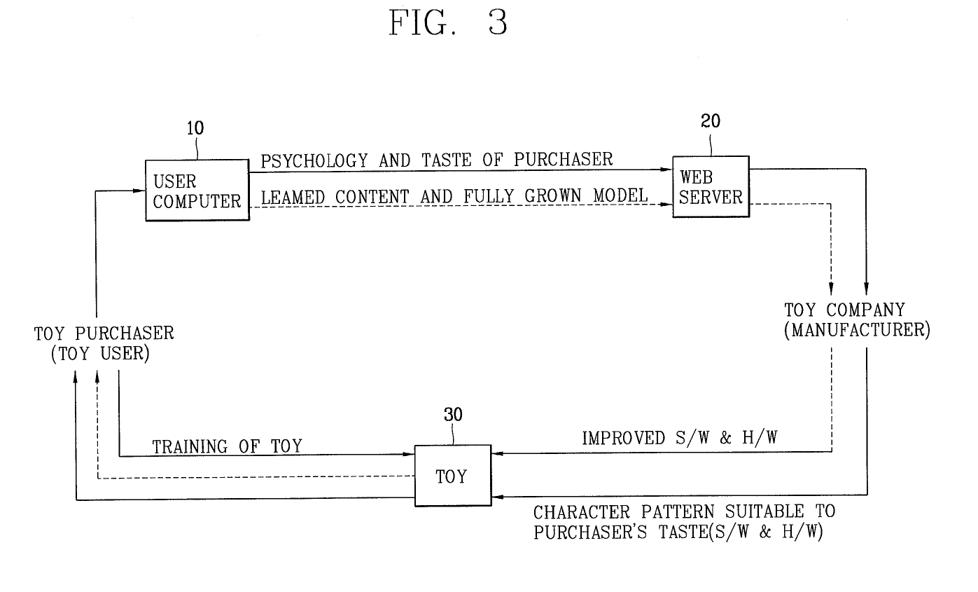

FIG. 3 is a block diagram illustrating an overview construction of the system for purchasing and/or managing an interactive toy over the Internet in accordance with a preferred embodiment of the present invention.

As shown in FIG. 3, the system for purchasing and managing a learning/growing type toy over the Internet includes a web server 20, a personal computer 10, and an interactive device exemplary designated as a toy 30. The web server 20 stores profile data for surveying and analyzing the psychology and tastes of a toy purchaser, generates data for fabricating a toy suiting a toy purchaser's tastes according to the information derived from the profile data, processes an order to purchase an interactive toy, determines a degree of maturity of a toy according to the learned content of a toy inputted by the purchaser, stores the fully grown models at each step of development and provides upgraded control software and/or hardware to a user for the toy.

The user or personal computer 10 is used to download profiles of interactive toys at various levels of development through the Internet, to input profile responses from the purchaser, and to upload a toy's learned content to the web server 20 from the toy 30 through a communication unit after a predetermined learning period elapses. The toy 30 is able to receive toy fabrication data generated in the web server 20 and to receive upgraded control software and/or hardware ordered by the purchaser over the computer 10. Alternatively, if the toy 30 has a function to be directly connected to the Internet, the learned/grown content of the toy 30 can be directly inputted to the web server 20 omitting the personal computer 10.

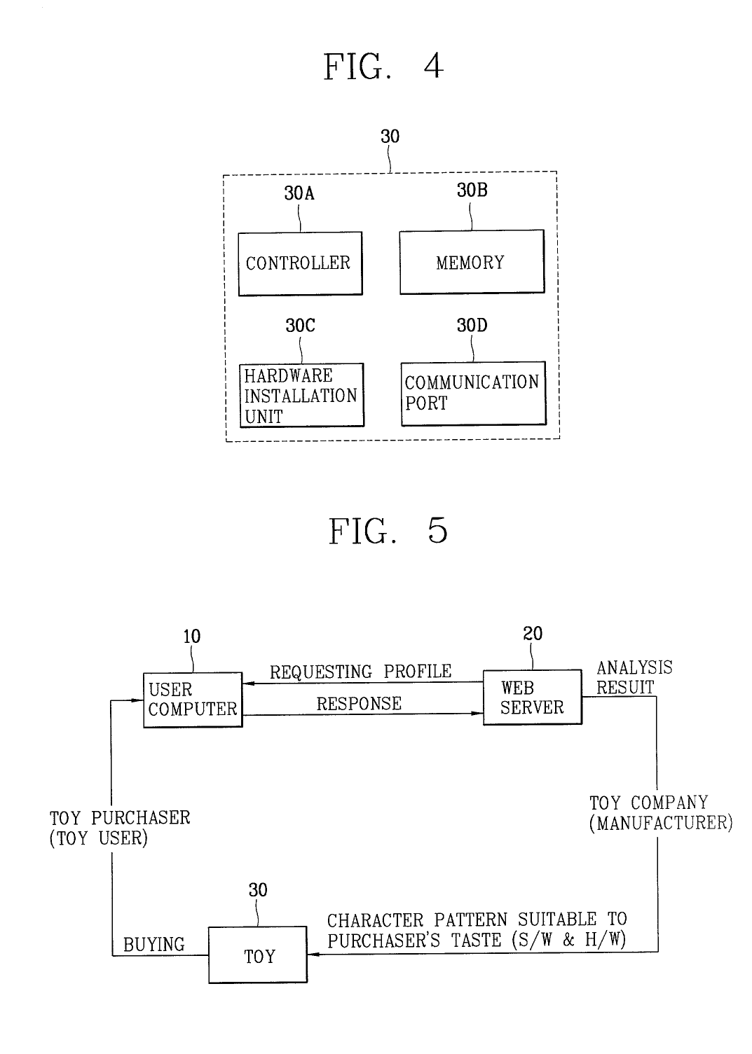

The following gives a general description of the interaction between the various components in the system of the preferred embodiments as seen in FIG. 3. Additional detail to each step of the process will be discussed with respect to FIGS. 5 to 15.

A purchaser makes an order for a toy to the web server 20 to purchase the toy 30. At this time, the web server 20 poses a question to the purchaser whether he or she wants a profile form for surveying and analyzing his or her psychology and taste. The purchaser expresses his or her intention by responding ‘yes’ or ‘no’ to the question of the web server 20, according to which the purchaser purchases a toy online or offline.

If the purchaser wants to survey and analyze his or her own psychology and taste to purchase a toy to his/her preferences, the purchaser may request the profile form from the web server 20, download a profile form through the Internet from the web server 20, fill in the form, and send back the form to the web server 20.

Then, the web server 20 receives the response result of the purchaser, analyzes the results and orders a toy 30 with a suitable control software and/or hardware amongst various control software and/or hardware representing diverse character patterns of toys previously stored in the web server 20. The toy company or manufacturer then sells it to the purchaser.

After the purchaser has had the toy 30 for a certain amount of time incorporating initial training into the interactive toy, the purchaser can input by means of a Internet connection, the learned content to the web server 20 and receive a fully grown model of the toy 30 at its step of development.

Thereafter, the web server 20 determines a degree of maturity of the toy on the basis of the learned content and the fully grown model of the toy at its step as selected by the purchaser, and the toy company provides the user with an upgraded control software and/or hardware according to the degree of maturity. The control software is provided to the purchaser through the Internet according to the degree of maturity and the hardware is provided to the purchaser in a store of a pertinent area or through the Internet purchasing system.

Accordingly, as shown in FIG. 3, in the purchasing/managing system of a learning/growing type toy in accordance with the preferred embodiments, after the toy 30 is sold to the purchaser, it passes a predetermined learning period by the user, and a web server 20 provides the user with a growth software and/or hardware according to a learned content to further grow the toy. In the system, purchasing and management can concurrently occur.

FIG. 4 is a detailed view of a toy 30 in accordance with the preferred embodiment of the present invention. As shown in FIG. 4, the toy 30 includes a controller 30A for receiving and running a control software or module according to the degree of maturity corresponding to the psychology and the taste of the purchaser. The controller 30A may include a processor for processing the control module received from the web server 20, a display panel for displaying images and motors and associated motor control processor to control the movement of the toy 30. In addition, the toy 30 includes a memory 30B storing the control module and a hardware installation unit 30C where supplementary hardware required for the grown toy 30 to perform an improved function is installed, where the hardware being installed corresponds to the psychology and taste of the purchaser. Moreover, the toy 30 has a communication port 30D, which can be used to connect to a computer 10 or a wired or wireless Internet connection.

The operation of the purchase system of the learning/growing toy using a web server as described above will now be explained.

FIG. 5 illustrates a purchase system of a learning/growing type toy using a web server 20 in accordance with the preferred embodiments. As shown in FIG. 5, the purchase system includes a user computer 10 for communicating between the toy purchaser and the web server 20; a web server 20 for receiving a profile form for surveying and analyzing the taste of a toy purchaser, determining a character pattern of a toy to be purchased from the profile form response, and providing a precustomized control software and/or a hardware corresponding to the character pattern; and a toy 30 having a character pattern suitable to the purchaser's psychology and taste according to the control software provided from the web server 20 and/or the hardware provided from the toy company at the time of purchasing of the toy.

FIG. 6 is a flow chart of a method for purchasing a learning/growing type toy using a web server in accordance with the preferred embodiment of the present invention. As shown in FIG. 6, control begins at block 400, where the toy purchaser accesses the web server 20 through the Internet using a browser program. The HTTP server 50 directs the toy purchaser through standard Internet purchase procedures and allows the user to order a toy 30. The server 20 receives the purchase order (at block 410) and allows an option to pre-customize the toy 30 to the user's tastes (at block 420). If the purchaser decides on the customization option or just to determine what type of toy would be best suited for the user, the user can request a profile questionnaire.

Preferably, the web server 20 builds a profile form based on an input template 67 with various questions regarding the interests and likes/dislikes of the user and sends the profile form to the user computer 10. At this time, the profile form is displayed on the personal computer 10 and the toy purchaser responds thereto and resubmits the completed profile form to the web server 20. The response result is received by the HTTP server 50 (at step 430), and the results are stored by the database interface 55 in the user's record 71a, b, . . . or n in the database 60.

The customization tool 40 then determines a character pattern of the toy according to the inputted response result of the purchaser, that is, according to the results of the psychology and taste test of the purchaser as stored in the database 60 (at step 440). Based on the results of the survey, an analysis on the psychology and taste of the purchaser is performed by the user analyzing unit 43. The character determining unit 47 takes the analysis results from the user analyzing unit 43 and endows a character pattern previously stored in the database 60 to the toy 30 to pre-customize the toy 30 to the user's tastes and preferences.

In this respect, various character patterns of toys are previously stored in the database 60. An order is sent to the toy manufacturer to incorporate the settings selected by the character determining unit 47 and to manufacture it accordingly. Thereafter, the control software and/or hardware corresponding to the determined character pattern of the toy 30 is adopted to the toy 30 (i.e. the control software corresponding to the character pattern of the toy is downloaded to the memory 30B of the toy 30, and supplementary hardware corresponding to the character pattern of the toy is mounted at the hardware installation unit 30C of the toy). The pre-customized toy 30 is then sold to users (at step 450).

The purchaser can purchase the toy 30 suitable to his or her taste at the point of sale. On the other hand, if the purchaser wants to directly purchase the toy, omitting the profile input form, he or she may directly purchase a toy from the toy company without the pre-customization off-line. However, even without the precustomization, standard software and hardware is included with the toy 30 which allows the toy 30 to grow and be customized based on the user's interaction.

FIG. 7 illustrates a managing system for a learning/growing type toy using a web server 20 in accordance with the preferred embodiments. As shown in FIG. 7, the managing system of a learning/growing type toy includes a toy 30 which behaves or responds to voice commands at a level corresponding to a certain learned level after being purchased; a personal computer 10 for receiving the learned/grown content by the toy purchaser through a communication unit, that is, a serial port or a parallel port, from the toy and outputting it; and a web server 20 for receiving the learned content, the fully grown model of the toy 30, and the identification number from the personal computer 10, determining a degree of maturity with a corresponding weight function, and providing the user a comparison table and a development step table according to the degree of maturity, so as to provide an improved control software and/or hardware to the toy accordingly.

The operation of the managing system of the learning/growing type toy using a web server constructed as described above will now be explained.

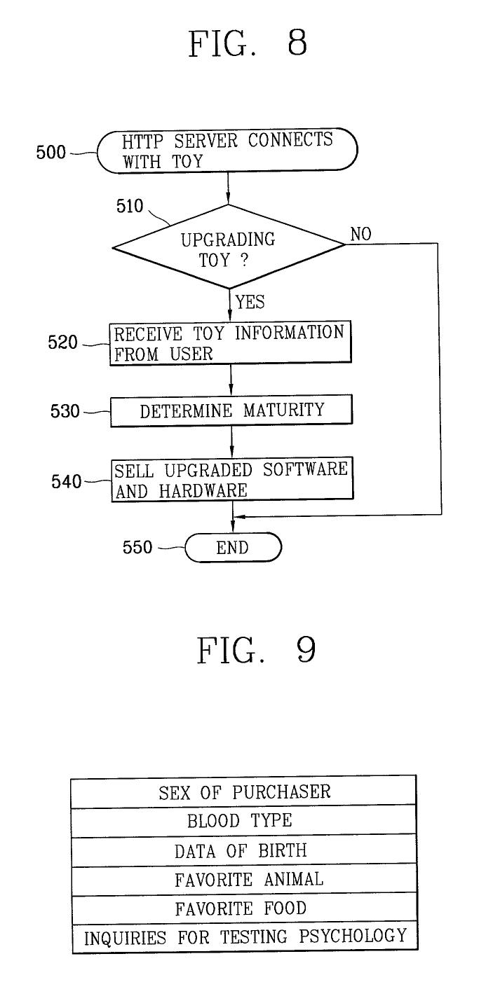

FIG. 8 is a flow chart of a method for managing of a learning/growing type toy using a web server in accordance with the preferred embodiment of the present invention. With reference to FIG. 8, first, whether the toy purchaser purchases a learning/growing type toy in online or offline, the user (the toy purchaser) has the toy 30 to learn and grow for a predetermined time period. After the predetermined learning period elapses, the web server 20 inquires the purchaser whether he or she wants to upgrade the toy 30 according to the learned degree. In response, if the purchaser wants to upgrade the toy 30 to have a further developed function (at step 510), the web server 20 asks the purchaser for the learned content, an identification number (ID) and the fully grown model of the toy 30 at its step. Preferably, the toy 30 shares the content of its internal memory containing the learned data with the web server 20.

Accordingly, the purchaser uploads the learned content stored in the memory 30B of the toy 30 to the personal computer 10 through the communication unit port (i.e. the serial port, the parallel port or a USB). Alternatively, if the toy 30 is constructed to be able to directly communicate with the web server 20 through wired or wireless communication, (i.e. wireless Internet), the toy 30 may directly input the learned content to the web server 20 without the need of a personal computer 10. The information is then sent together with the toy ID and user's selection of what stage of development the toy has reached (i.e. the fully grown model at its step of development) to the web server 20 (at step 520).

At step 530, the web server 20 determines the degree of maturity of the toy 30 through a weight function according to fully grown models by steps as stored in database 60. The weight function considers both the learned content uploaded from the toy 30 and the fully grown model selected by the purchaser to determine the degree of maturity of the toy 30. Thereafter, the web server 20 also provides the purchaser with a user comparison table and a development step table by growth types (to be described) made on the basis of the maturity.

In addition, the web server 20 provides the purchaser with training guidance, a fully grown model type by steps, a game character, or the like, given to toys 30 to participate in various contest in a virtual space or in actual space.

According to the degree of maturity, the toy company provides the upgraded control software and/or hardware for the toy to the user (at block 540). The upgraded control software can allow the toy 30 to perform additional functions according to the growth degree of the toy 30, and additional hardware components (i.e., arms, parts of a toy, etc) may be required to perform the additional functions. The toy company can download the upgraded control software to a controller 30A of the toy 30 through the Internet, and the upgraded control hardware can be provided to the purchaser in a toy store or by using an additional purchasing system over the Internet. Once the improved software and/or hardware is installed, the purchaser can further train the toy 30 until the toy 30 is ready for another upgrade. The growing step as described above is repeatedly performed until the upgrading step is terminated. However, if the purchaser does not want to upgrade the toy 30 at step 510, the managing method of the learning/growing type toy is terminated.

FIG. 9 is a diagram showing sample profile items of a toy purchaser to be provided to the web server in accordance with the preferred embodiment of the present invention, which includes items of ‘sex of the purchaser’, ‘date of birth’, ‘blood type’, ‘favorite animal’, ‘favorite food’, ‘questions for testing psychology’, etc. This information is preferably saved in the user record 71a, b, . . . or n in the database 60, and used by the customization tool 40 to determine the character pattern of the toy 30 during purchase process.

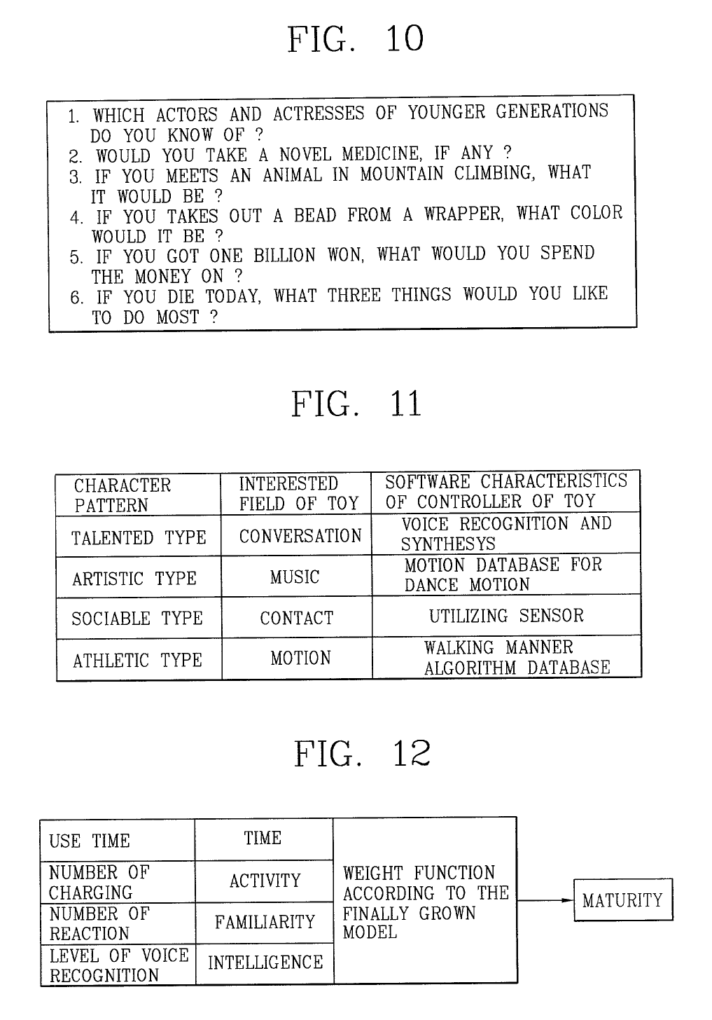

FIG. 10 is an exemplary illustration of questions for checking the psychology of the purchaser and determining the profile information of FIG. 9 in accordance with the preferred embodiment of the present invention. Example questions include questions such as ‘Which actors and actresses of younger generations do you know of?’, ‘Would you take a novel medicine, if any?’, ‘If you meet an animal while mountain climbing, what would it be?’, ‘If you took out a bead from a wrapper, what color would it be?’, ‘If you got one billion won (approximately one million U.S. dollars), what would you spend the money on?’, or ‘if you were to die today, what three things would you like to do most?’.

The items described in FIGS. 9 and 10 are used to analyze the psychology and the taste of the purchaser. Without being restricted thereto, various other items may be used to analyze the psychology and taste of the purchaser, and used to determine the character patterns given to a particular toy 30. The character patterns of the toy 30 are stored in the character database table 80 in the database 60 and accessed by the toy character determining unit 47 in determining which character pattern best fits the preferences and tastes of the purchaser.

FIG. 11 is an exemplary illustration of control software corresponding to each character pattern of toys in accordance with the preferred embodiment of the present invention. As shown in FIG. 11, the character patterns include a talented type, an artistic type, a sociable type and an athletic type. Corresponding characteristic of each character pattern (i.e. interested field of the toy) and the respective software characteristics of the controller are also listed in FIG. 11. Thereby choosing a particular type of control software, the interactive toy 30 can be varied to the user's preferences and tastes.

FIG. 12 is a diagram showing a method for determining a degree of maturity of a toy in accordance with the preferred embodiment of the present invention. The degree of maturity is determined by comparing the development of the learning/growing type toy 30 in various categories with the fully grown model at the next development step (i.e. a weighted calculation). Categories compared include: use time of the toy 30, the number of chargings, the number of reactions of a tactile sensor and a level of voice recognition from the purchase date to the time when the learned content of the toy is inputted to the web server 20. The results of the weighted calculation as well as the selection of desired level by the user will allow the web server 20 to determine a maturity level of the toy 30.

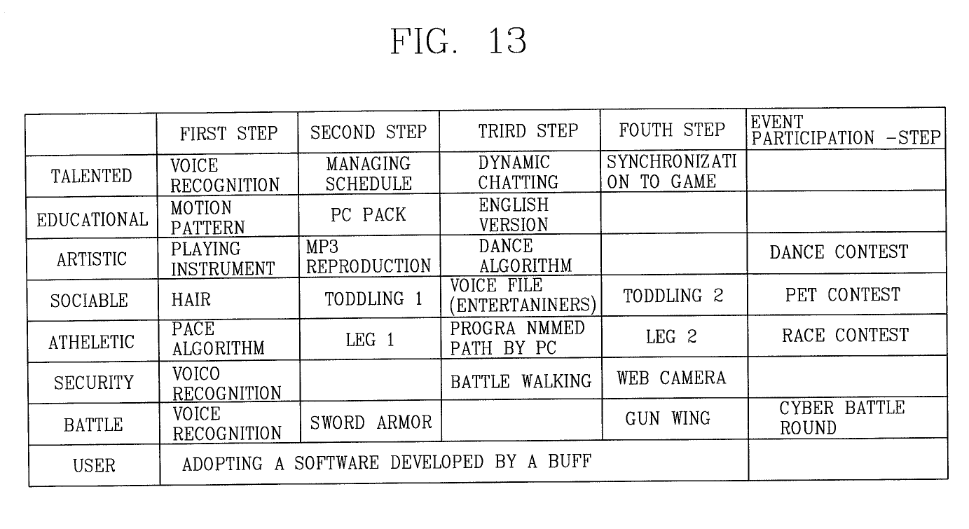

FIG. 13 is an exemplary illustration of types of fully grown models of learned/grown toys and pertinent development steps in accordance with the preferred embodiment of the present invention. For example, in case of the talented type of toy, at the first step (i.e. level of development), the toy 30 recognizes the voice of a greeting or a basic operation command (i.e., ‘forward!’, ‘sit’, ‘up’, ‘back’, etc.) and does behaviors accordingly. At the second step, the toy 30 performs a function of verbally informing the user of specific events at a set time. (i.e., ‘Please wake up’, ‘It's time for an appointment’). At the third step, the toy 30 shows a dynamic reaction to a comment of the purchaser (for example, it smiles or reacts on a comment of “you are pretty”). Without being limited to the above described example, the dynamic reaction at the third step may come in many forms, such as reacting or changing behavior based on the chat conversation in chat room as the toy 30 is connected to the Internet.

Another example of a fully grown model at various stages of development is the educational variety. At the first step, the toy 30 can mimic a specific, well-known character (e.g. a teletobie®). At the second step, the toy 30 can operate according to commands of several steps previously stored from an educational CD-ROM. At the third step, the toy operates or reacts in a foreign language (i.e., English).

Another example of a growth type is the user type. In the user type variety, the toy 30 can take on characteristics developed by other users. Such characteristic types may be developed by true fanatics of the interactive toys and can take on many different forms. For example, users may develop “flirty” type software or “rebel” type software. These user created growth type software can be downloaded from the Internet and stored in the memory 30B of the toy, and operate or react accordingly thereto.

According to the growth types or the development steps, the toys may participate in various contests, such as a dance contest for artistic toys, a sweet gesture contest for sociable toys, a race contest for athletic toys, a battle contest for battle-type toys to be performed in a virtual space. For the various events for the toys, the web server 20 provides image characters to each toy by growth types and the development steps, assigns an identification number to the toys, and displays the contest scene on the personal computer 10 of the purchaser through the Internet. Accordingly, the purchaser can watch their toys compete with other toys of other purchasers as the toys participate in the contests, and makes a relative evaluation with respect to other toys on the basis of the records of the contests. This kind of events may be held in a real space, without being restricted to the virtual space.

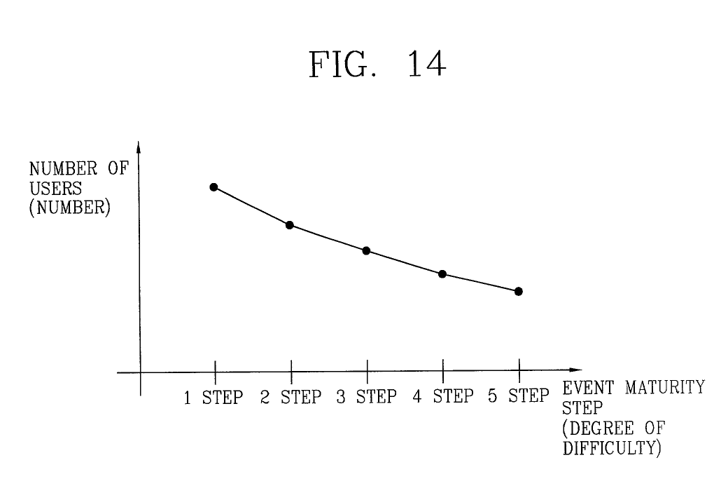

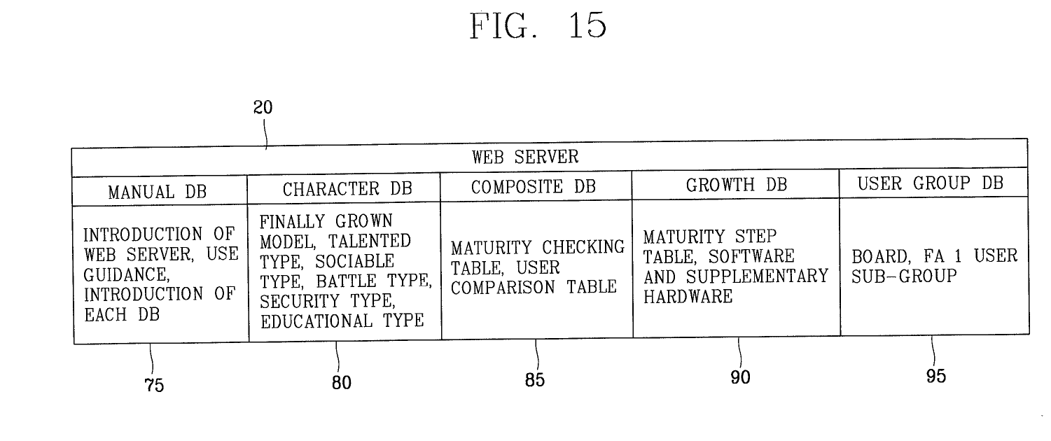

FIG. 14 is a graph showing comparison of the number of users of toys for a development by steps of toys in accordance with the preferred embodiment of the present invention. As shown in FIG. 14, the web server 20 surveys the number of purchasers owning toys by steps of development illustrated in FIG. 13 and provides the survey result to the users through the Internet. This is to inform the users of the ranking of the toys owned by the users.

In order to provide various services as illustrated in FIGS. 13 and 14, the database 60 includes database tables 75, 80, 85, 90, 95 as shown in FIG. 2 and described in greater detail in FIG. 15 in accordance with the preferred embodiments of the present invention. As shown in FIG. 15, the manual database 75 stores in one or more records 76a, b, . . . n instructions for the web server 20, a user manual containing instructions for learning/growing the toy and procedures to upgrade the toy according to the methods disclosed above.

A character database 80 is provided to store in one or more records 81a, b . . . n the fully grown models of learning of each step, including a fully grown model for a s talent type, a sociable type, a battle type, a security type, and a educational type. A composite database 85 contain records 86a, b, . . . n to keep track all the interactive toys registered with the web server 20. Each record tracks an identification number (e.g., a serial number), a purchase date, the toy name given by the purchaser, the fully grown model of the toy desired by the user, the current state of development of the toy 30, and provides a maturity degree checking table and a user comparison table for each registered toy 30. The maturity degree checking table, as shown in FIG. 12, stores the values of the weight function when compared to the fully grown model at each step based on use time, the number of charging, the number of reaction and the level of voice recognition. As shown in FIG. 14, the user comparison table provides a reference ranking by comparing the degree of maturity of toys with other toys registered with the web server 20. Finally, the user group database 95 stores information in records 96a, b, . . . n to manage gatherings of users and provides a user message board, frequently asked questions (FAQ) and sub-group gatherings based on the development of the user's toys 30.

Another method in which the web server 20 directly controls the toy 30 through the Internet and the personal computer 10 will now be described.

The web server 20 advances the degree of maturity of the toy owned by the purchaser step by step whenever a predetermined time elapses. In addition, the web server 20 inputs a control command (a voice or a signal) to the toy 30 through the Internet and the user computer 10 at an arbitrary time zone. According to the control command, the toy 30 shows a programmed reaction and further shows a behavior specified in the development step table of FIG. 13.

Accordingly, the purchaser has his or her own toys to learn, or compares and determines the grown state on the basis of the toy 30 learned by the information obtained from the web server 20. In addition, by using the above method, the purchaser may also request the web server 20 to have his or her own toy 30 to learn.

As so far described, the method for purchasing and managing of a learning/growing type toy using a web server has many advantages. For example, before selling a learned/grown toy to a purchaser, the psychology and the taste of the purchaser is first analyzed and then a control software and/or hardware is installed in the purchased toy, allowing the purchased toy to have a character suitable to the purchaser's psychology and the taste according to the analysis. Accordingly, the purchaser can be much interested in the toy at the initial stage and have the toy to learn and grow.

In addition, the web server guides the learning/growing procedure, provides a user comparison table so as for the purchaser to compare his or her own toys with other ones of other purchasers for the learned/grown state of toys. And various contests are held in the cyber space to allow the purchasers to objectively compare their own toys with each other, arousing learning/growing desire of the users for their toys with much interest.

Moreover, since the control software and/or hardware are provided suitable to the level of each growing step, purchasers would be hardly tired of toys and have a great interest continuously.

The foregoing embodiments and advantages are merely exemplary and are not to be construed as limiting the present invention. The present teaching can be readily applied to other types of interactive electronic apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for programming an interactive device using a web server, wherein the interactive device has a processor and a memory for receiving programming signal from the web server to control the interactive device, comprising the steps of:
inquiring a purchaser for preference profile information;
receiving a response to the preference inquiry;
determining an initial character pattern for the interactive device based on the received response from the purchaser; and
selecting a control module corresponding to the determined character pattern for the interactive device.

2. The method according to claim 1, further comprising:
querying the purchaser on whether the interactive device needs to be upgraded;
receiving information about a development level of the interactive device;
receiving information selected by the purchaser on the desired development level of the interactive device;
determining a degree of maturity of the interactive device from the received information; and
selecting an upgraded control module for the interactive device based on the determined degree of maturity.

3. The method of claim 1, wherein the preference profile information includes at least one of purchaser gender, date of birth, blood type, favorite animal.

4. The method of claim 1, wherein the character pattern for the interactive device comprises at least one of a talented type, an educational type, an artistic type, a sociable type, an athletic type, a security type, and a battle type.

5. A method for managing an interactive device using a web server, wherein the interactive device has the ability to learn and advance in levels of development, the method comprising the steps of:
teaching the interactive device for a predetermined time period;
uploading the learned/grown content of the interactive device to the web server;
selecting a fully grown model of the interactive device at a next development level;
determining a maturity level of the interactive device based on the uploaded learned/grown content and the selection of the fully grown model;
deriving a user comparison table for the maturity level; and
determining an upgraded control module for the interactive device according to the maturity level.

6. The method of claim 5, wherein the fully grown model of the interactive device is a member of a set of full grown models comprising a talented type, an artistic type, a sociable type, an athletic type, a security type, an educational type and a battle type.

7. The method of claim 5, wherein the maturity level of the interactive device is determined by a weighted comparison of the uploaded learned/grown content of the interactive device with the values for a fully grown model at different levels of development.

8. The method of claim 7, wherein the weighted comparison is determined on the basis of at least one of use time of the interactive device, a number of recharging, a number of tactile sensor reaction and a number of voice recognition.

9. The method of claim 5, wherein, in the step of determining the upgraded control module further comprises providing website guidance, details on upgrading the control software and/or hardware from the web server, and a guide plan for teaching the interactive device to the next level of development.

10. The method of claim 5, wherein the step of determining the upgraded control module further comprises providing a character database table including information on the fully grown models of the interactive device according to levels of development.

11. The method of claim 5, wherein the step of determining the upgraded control module further comprises providing a composite database table to store an identification number, a purchase date, a name given by the purchaser to the interactive device, a growth model of the interactive device desired by the purchaser, a current growth state of the interactive device, a maturity degree checking table, and a user comparison table.

12. The method of claim 11, wherein the step of determining the upgraded control module further comprises providing a growth database table to classify the control module for the interactive device according to the level of development and providing an upgraded control module corresponding to the level of development of the interactive device according to a maturity level checking table of the composite database.

13. The method of claim 5, wherein the step of determining the upgraded control module further comprises providing a user group database table to manage a gathering of users in an Internet-based cyber virtual space, a user board, frequently asked questions and a sub-group gathering of users categorized by the development of the interactive device.

14. The method of claim 5, further comprises:
providing an event where purchasers who obtained the upgraded control module place respective interactive devices in a contest categorized by fully grown models.

15. The method of claim 5, wherein the step of determining the upgraded control module further comprises downloading the upgraded control module through the Internet.

16. A system for purchasing and customizing an interactive device using a web server, wherein the interactive device has the ability to learn and advance in levels of development, wherein the web server comprises:
means for inquiring a purchaser for preference profile information;
means for receiving a response to the preference inquiry;
means for determining an initial character pattern for the interactive device based on the received response from the purchaser; and
means for selecting a control module corresponding to the determined character pattern for the interactive device.

17. The system according to claim 16, wherein the web server further comprises:
means for querying the purchaser on whether the interactive device needs to be upgraded;
means for receiving information about a development level of the interactive device;
means for receiving information selected by the purchaser on the desired development level of the interactive device;
means for determining a degree of maturity of the interactive device from the received information; and
means for selecting an upgraded control module for the interactive device based on the determined degree of maturity.

18. A system for purchasing and managing an interactive device using a communication medium, the system comprising:
a web server for providing a profile data having information for surveying and analyzing preferences of a purchaser, generating data for fabricating the interactive device suiting a purchaser tastes according to the information described in the profile data, processing an order content of the purchaser in case the purchaser desires to purchase the device directly without utilizing the psychology and taste analysis, determining a degree of maturity of the device according to the learned content and the fully grown model of the device at a certain step of development as inputted by the purchaser, and providing an upgraded control module for the interactive device;
a personal computer for downloading a profile form through the Internet, providing the profile form to the purchaser, inputting a response of the purchaser to the profile form, downloading the learned content from the interactive device through a communication unit after a predetermined learning period elapses and inputting the learned content to the web server; and
a device for receiving fabrication data generated in the web server and the upgraded control module through the personal computer.

19. The system of claim 18, wherein the communication unit is at least one of a serial port, a parallel port, and a USB.

20. The system of claim 18, wherein the web server makes a user comparison table which compares the number of users of the interactive devices by development steps and provides a survey result through the communication medium to each purchaser, so that the purchaser is aware of standing of the interactive device.

21. The system of claim 18, wherein the web server provides the purchaser with a development step table which represents functions according to each development step by growth types of the interactive device, and a list of software and hardware suitable to the development step of the interactive device.

22. A system for purchasing an interactive device using a web server, the system comprising:
a personal computer for communicating between a purchaser and the web server;
the web server for sending and receiving a profile form for the purchaser to survey and analyze the tastes of the purchaser, determining a character pattern of the interactive device to be sold based on the received profile form, and providing a customized control module corresponding to the character pattern; and
the interactive device having the character pattern suitable to the preferences of the purchaser as established by the customized control module.

23. The system of claim 22, wherein the web server further comprises:
an HTTP server for providing a profile form to the purchaser and receiving the corresponding response result;
a user analyzing unit for analyzing the response result of the purchaser and outputting an analysis result; and
a device character determining unit for receiving the analysis result and selecting a character of the device from a stored set of characters.

24. The system of claim 22, wherein the interactive device further comprises:
a controller for running an upgraded control software, and
a hardware installation unit at which supplementary hardware can be added to perform an improved function.

25. A system for managing an interactive device comprising:
the interactive device responsive to voice commands at a level corresponding to a training level and formulating a learned content;
a personal computer for receiving the learned content from the interactive device and outputting the learned content; and
a web server for receiving the learned content and processing a fully grown model of the interactive device and an identification number from the personal computer and further determining a maturity level with a corresponding weight function, and for providing a user comparison table and a development step table according to the maturity level in order to provide an upgraded control module to the interactive device.

26. The system of claim 25, wherein the web server further comprises means to hold various events and contests for the interactive device to allow relative evaluation of the interactive device with other similar interactive devices.

27. The system of claim 25, wherein the web server provides image characters to each interactive device by growth types and development steps, assigns an identification number to the interactive device, and displays a contest scene on the personal computer through the Internet.

28. A system for exchanging information over a communication medium, the system comprising:
a first processor having a server for providing a control module used for remote processing, wherein the control module is selectively chosen;
a second processor linked to the first processor through the communication medium to exchange data with the first processor;
an interactive device having at least a processor and a memory and adapted to communicate with the first processor, wherein the interactive device includes a sensor for collecting data and formulating a learned module, the interactive device receiving the control module from the first processor and sending the learned module to the first processor, and wherein the control module from the first processor is selectively chosen in response to the learned module; and
a communication link for linking the interactive device to the second processor, wherein the control module includes an executable program for sensory functions to be performed by the interactive device.

29. The system of claim 28, wherein the interactive device performs physical motor functions in response to the control module received from the first processor.

30. The system of claim 29, wherein the learned module is responsive to an operation duration of the interactive device.

31. The system of claim 30, wherein an updated control module is selected in the first processor in response to the learned module to allow the interactive device to perform more advanced functions.

32. An interactive device for use with a first processor having a server for providing a control module used for remote processing, wherein the control module is selectively chosen; a second processor linked to the first processor through Internet to exchange data with the first processor, the interactive device comprising:
a processor for receiving and executing the control module;
a memory for storing data;
a communication port adapted to communicate with the second processor;
a sensor for collecting data and outputting to the processor, wherein the processor compiles a learned module based on sensory data and communicates to the first processor to receive an updated control module in response to the learned module.

33. The interactive device of claim 32, further comprising a motor controller for controlling movement of the interactive device in response to the control module received from the first processor.
